(19) United States
(12) Patent Application Publication
(10) Pub. No.: US 2025/0282161 A1
(43) Pub. Date: Sep. 11, 2025

(54) METHOD FOR PRINTING A PAPER, AND DIGITAL PRINTING DEVICE

(71) Applicant: SWISS KRONO Tec AG, Luzern (CH)

(72) Inventors: Frank Oldorff, Schwerin (DE); Falko Geitz, Zernitz-Lohm (DE)

(21) Appl. No.: 18/860,317

(22) PCT Filed: May 2, 2023
(86) PCT No.: PCT/EP2023/061580

§ 371 Date: Oct. 25, 2024

(30) Foreign Application Priority Data
May 5, 2022 (EP) 22171800.0

(51) Int. Cl. B41J 29/377; B41J 2/005; B41J 2/01; B41J 2/165; B41J 2/21; B41J 3/407; B41M 5/025

(52) U.S. Cl. CPC B41J 29/377; B41J 2/0057; B41J 2/16579; B41J 2/2103; B41J 3/4073; B41M 5/0256; B41J 2002/012

(57) ABSTRACT

The disclosure relates to a method for printing an object, which is not a paper, by a digital printing system which has a plurality of ink application units for applying printing ink of different colours, in which method an ink carrier element is guided past the ink application units in a feed direction. The digital printing system has a device which is designed and suitable for preventing or reducing the formation of condensation on the ink application units, and this device is used to prevent or reduce the formation of condensation on the ink application units. The device has a temperature-control device and an electrical controller, wherein the temperature-control device is designed to influence a temperature of the ink application units. The electrical controller is designed to control the temperature-control device in such a way that the ink application units have different temperatures, wherein the temperatures of the ink application units increase in the feed direction and the temperatures of two adjacent ink application units differ by at least 0.5° C. and by at most 1.5° C. The temperatures of the first ink application unit in the feed direction and of the last ink application unit in the feed direction differ by at most 10° C.

### FIELD OF INVENTION

The invention relates to a method for printing on an object that is not paper by means of a digital printing facility which has multiple ink application units for applying printing ink of different colours to the paper, wherein the method involves guiding an ink carrier element past the ink application units in a feed direction, wherein the device comprises a temperature control device and an electrical control unit, the temperature control device being configured to influence a temperature of the ink application units and the electrical control unit being configured to control the temperature control device in such a way that the ink application units are at different temperatures. The invention also relates to a digital printing facility that is able and configured to print on a paper using such a method.

### BACKGROUND

Printing onto objects that are not paper has been known from the prior art for many years. During the production of laminate panels, for example during the production of floor panels or wall and ceiling coverings, but also furniture boards, the upper sides, which will be visible during subsequent use, are given a decor. It can be printed onto a decorative paper, which subsequently has to be bonded with the core, i.e. with the actual board, such as a wood-based material panel; alternatively, the printing ink can be printed onto the object, such as the laminate panel or a part thereof, for example the core of the laminate panel. In the prior art it is known to apply the printing ink directly to the object using, for example, roller printing. It has been proven that printing directly onto a wood-based material panel is difficult and in many cases impossible to reconcile with the high demands placed on print quality and reproducibility, particularly in this area of application. In the case of direct printing, the ink carrier is the object.

As a result, indirect printing is often used in this case. In this case, the ink carrier element to which the printing ink is applied is, for example, a printing cylinder which applies the printing ink, which is applied to the printing cylinder via the ink application units, to an application roller, which prints onto the actual object to be printed on. Alternatively, a print belt can also be used. This print belt is tensioned and set in motion by at least two rollers, for example a printing roller, which can also be called a printing cylinder, and a conveyor roller, which can also be called an application roller. The ink application units print the printing ink onto the print belt, which in this case constitutes the ink carrier element. From there, it is transferred to the actual object to be printed on.

Digital printing facilities which can print onto ink carrier elements have also been known for many years. So-called single-pass digital printing facilities, in which the ink carrier element to be printed only has to pass through the printing facility once, are used in the packaging industry, for example, to print onto packaging materials, such as cardboard boxes. However, the requirements for the print and the quality of the resulting decor are considerably lower in this case than for the production of decors, for example for the aforementioned purposes. This applies to both the quality of the individual print of the decor and the reproducibility of the decors, which often have to be produced in large quantities. Moreover, objects with the same decor are often produced in different batches with very large time intervals in between, meaning the demand on reproducibility is increased even further.

It known from the prior art that various parameters influence the quality of the decor produced. For example, this relates to the ink carrier element used and the object to be printed on, the quantity and type of printing ink applied and, where applicable, the quantity and type of the primer used, which can also be referred to as a primer coating, but also to environmental factors such as humidity or temperature. However, these parameters, which cannot usually be optimised independently from other, but rather have a mutual impact on one another, not only have an influence on the ink carrier element to be printed and, where applicable, the object to be printed on, but also on the digital printing facility used for printing. For example, it is known that a build-up of condensation on the print head may occur. This has a negative impact on the quality of the print results. Due to the condensation on the print head, individual nozzles of the print head, through which ink passes, may become clogged and blocked. This may lead to the failure of a whole print head. To prevent this from happening, increased cleaning efforts are required to remove any condensation that forms. In addition, this cleaning means that a cleaning liquid used for cleaning purposes is required and used up, which increases production costs. Printing ink is also expended during cleaning, which likewise has disadvantageous effects.

If condensation is not recognised and removed in time, it can lead to the production of rejects, which also increases the costs of production and the necessary use of materials, leads to longer downtimes of the printing facility and results in increased maintenance and repair costs.

### SUMMARY

The invention is therefore based on the task of proposing a method with which safe and continuous production can be enabled more effectively.

The invention solves the task addressed by way of a method for printing onto an object that is not paper by means of a digital printing facility which has multiple ink application units for applying printing ink of different colours to the paper, wherein the method involves guiding an ink carrier element past the ink application units in a feed direction, wherein the device comprises a temperature control device and an electrical control unit, the temperature control device being configured to influence a temperature of the ink application units and the electrical control unit being configured to control the temperature control device in such a way that the ink application units are at different temperatures, wherein the digital printing facility comprises a device that is configured and able to prevent or reduce a build-up of condensation on the ink application units, and wherein the build-up of condensation on the ink application units is prevented or reduced by this device, and wherein the method is characterised in that the temperatures of the ink application units increase in the feed direction and the temperatures of two neighbouring ink application units differ by at least 0.5° C. and at most 1.5° C., the temperatures of the first ink application unit in the feed direction and of the last ink application unit in the feed direction differing by at most 10° C.

Consequently, the ink carrier element to be printed on is guided past the various ink application units within the digital printing facility. In the process, the printing ink to be applied by the respective ink application unit is applied to the ink carrier element. Once the ink carrier element has been guided past all available ink application units, the desired decor is printed on the ink carrier element. In the case of indirect printing, this decor is then transferred to the object to be printed on by rolling the ink carrier element on said object. In the case of direct printing, the ink carrier element is the object.

Rather than having to remove any resulting condensation, as is the case in the prior art, and/or maintaining, cleaning or repairing the printing facility, the invention renders it possible to reduce or completely prevent the build-up of condensation, thereby solving the problem. According to the invention, a device is provided for this purpose which preferably constitutes part of the digital printing facility, and is configured and able to prevent or reduce the build-up of condensation. In the method according to the invention, it does perform this task. In particular, this means that less condensation develops in a digital printing facility with said device than in a digital printing facility without it. This applies in particular when otherwise identical parameters are used.

According to the invention, the device has a temperature control device and an electrical control unit. The temperature control device is configured to influence a temperature of the ink application units. This can be done in different directions. The temperature control device preferably comprises a heater, which is configured to increase the temperature of the ink application units. Particularly preferably, the heater is configured to increase the temperature of the ink application units independently from each other. Alternatively or additionally, the temperature control device preferably has a cooler, which is configured to reduce the temperature of the ink application units. Particularly preferably, the cooler is configured to reduce the temperature of the ink application units independently from each other.

The electric control unit is configured to control the temperature control device. In a preferred embodiment, the digital printing facility has at least one temperature sensor. Particularly preferably, the digital printing facility has at least one temperature sensor per ink application unit. The temperature sensor is configured to transmit measurement data to the electrical control unit containing information on the temperature of the respective ink application unit. It is thus possible to measure the temperature. The electrical control unit is preferably configured to access an electronic memory in which a target temperature value for the respective ink application unit is stored. The electrical control preferably is or contains an electronic data processing device. The electrical control unit compares the temperature of an ink application unit measured by the sensor with the target temperature stored in the electronic memory and is configured to control the temperature control device on the basis of the result of this comparison. If the measured temperature deviates from the target temperature by more than a predetermined value, the electrical control unit sends control signals to the temperature control device, which then changes the temperature of the ink application unit. If the measured temperature is greater than the stored target temperature, the cooler of the temperature control device is controlled by the control signals and reduces the temperature. If the measured temperature is lower than the stored target temperature, the heater of the temperature control device is controlled by the control signals.

According to the invention the electrical control unit is configured to control the temperature control device in such a way that the ink application units are at different temperatures. Particularly preferably, the temperatures of the ink application units increase in the feed direction. This design is based on the knowledge that the quantity of liquid printing ink applied to the ink carrier element increases in the feed direction. This also increases the risk of a build-up of condensation from the amount of liquid applied. The higher the temperature of the ink application unit, the lower the likelihood that any liquid found in the area surrounding the ink application unit will condense on the ink application unit. Therefore, it is generally advantageous if the temperatures of the ink application units increase in the feed direction.

The temperatures of two neighbouring ink application units differ by at least 0.5° C., preferably by at least 0.7° C., especially preferably by at least 1.0° C. The temperatures of two neighbouring ink application units differ by at most 1.5° C., preferably at most 1.3° C., especially preferably at most 1.0° C.

In one specific embodiment example, the digital printing facility has, for example, four ink application units, the temperatures of which increase in the feed direction. In this specific embodiment example, the temperature of the first ink application unit is 29° C., the second ink application unit is 30° C., the third printing unit is 31° C., and the fourth printing unit is 32° C.

On the one hand, it is advantageous if the temperature between the ink carrier element to be printed on and the print head is as low as possible, so as to reduce the risk of a build-up of condensation. Since the ink carrier element also heats up as it passes through the digital printing facility, it is advantageous if the temperature of the ink application units also increases in the feed direction. On the other hand, the quantity of printing ink applied by the respective ink application unit increases as the temperature of the ink application unit increases. It is therefore advantageous to limit the overall difference in temperature between the first and last ink application unit. The temperatures of the first ink application unit in the feed direction and the last ink application unit in the feed direction differ by at most 10° C., preferably at most 7° C., especially preferably at most 5° C.

Preferably, the digital printing facility has a cooling device that is configured to cool the ink carrier element. This is especially advantageous when an indirect printing procedure is used. In this case, as previously described, the printing ink is transferred by the ink application units onto the ink carrier element and by said element onto the object, either directly or indirectly. The ink carrier element therefore rotates within the digital printing facility and is guided past the ink application units multiple times. It is, however, still a single-pass facility, as all colours used for the print are applied to the ink carrier element in a single cycle. The ink carrier element heats up slightly with every revolution, so that the temperature of the ink carrier element can increase during operation of the digital printing facility. A cooling device is provided to reduce the associated increased risk of a build-up of condensation. The device preferably has an additional temperature sensor, which is configured to determine the temperature of the ink carrier element. The measured values determined by this additional sensor are transmitted to the electrical control unit, preferably the electronic data processing device, where they are preferably compared with stored target values. The electrical control unit controls the cooling device depending on the result of this comparison.

In one preferred embodiment, the device has at least one air stream deflector that is arranged between two ink application units and is configured and able to deflect an air flow from one ink application unit to an adjacent ink application unit. An air stream that would flow from one ink application unit to an adjacent ink application unit without the air stream deflector is thus deflected by the air stream deflector. An air stream deflector can be designed, for example, in the form of a wall or a board that is placed or positioned in the path of the actual air flow. This is particularly advantageous in order to prevent a spray of printing ink, which is produced when the printing ink leaves the ink application unit, from being directed or blown from one ink application unit to the adjacent ink application unit by air flows which may be caused, for example, by the moving parts of the digital printing facility, by the ink carrier element moving through the digital printing facility and/or by air flows in the hall in which the method is carried out. This also reduces the amount of liquid at the point of the neighbouring ink application unit, which lowers the risk of a build-up of condensation.

Particularly preferably, the device has at least one air stream deflector between each two neighbouring ink application units. This means that whenever two ink application units are arranged adjacent to one another, there is at least one air flow deflector between these two ink application units.

The device preferably has at least one air suction device that is arranged between two neighbouring ink application units and is able and configured to suck away air between the two ink application units. Particularly preferably, the device has at least one air suction device between each two neighbouring ink application units. This means that whenever two ink application units are arranged adjacent to one another, there is at least one air suction device between these two ink application units. The air suction device sucks away an ink spray produced when the printing ink leaves the ink application unit. The air suction device is preferably part of a cooler of the temperature control device.

Advantageously, the device has a housing that surrounds the ink application units. This can keep moisture, spray and other factors that accelerate or aid the build-up of condensation away from the print heads of the ink application units.

In one preferred embodiment, the digital printing facility has a monitoring unit that is configured to detect a build-up of condensation on at least one ink application unit.

The invention also solves the task addressed by way of a digital printing facility of the type described here, which is configured and able to print onto the object that is not paper using a method described here.

In one specific embodiment example, a digital printing facility has at least one four-colour set, preferably a five-colour set for printing. The ink order is optimised for printing the decor (for example: blue—reddish yellow—red-greenish yellow—black in the case of a colour set containing five colours). The waveform created, i.e. the drop shape produced on the ink application unit, allows a controllable temperature tolerance of the print heads of at least 3° C., preferably 6° C., particularly preferably 10° C., without an obvious colour deviation being visible in the decor.

The digital printing facility is calibrated and profiled according to its chemical-physical properties and to the object to be printed on. Here, it is necessary to determine the maximum ink application quantity and to limit ink use to a necessary degree.

The print data is created by the determined print profile and the resulting version X is ripped in the printing press. The ink application quantity is determined from the ripped data by means of printing software.

The first step is to sand the upper side of a board to be printed on (for example a ROH HDF board, 2070×2800 mm). In the next step, a primer coating with a melamine resin base is applied and dried at 210° C., preferably at 200° C. Multiple layers of white (for example a solution of water and titanium dioxide) are then applied. Drying is carried out online after each application of ink; the drying temperature is gradually reduced to 190° C. from the first application to the last application of ink. In the subsequent step, the surface of the board to be printed on is provided with a primer (for example a reactive primer) and dried. This results in a layer structure of 22 g/m², preferably 20 g/m². The ready-to-print coated board is cooled from 57° C. to 38° C., preferably to 36° C., in a cooling paternoster prior to the digital board printing.

The optimised board is printed online at a facility speed of 80 m/min, preferably 85 m/min. A water-based ink system is utilised for this process. In terms of structure, the decoupling of the printing unit from the substrate, i.e. the board to be printed on, can be achieved by means of an application roller or transfer conveyor belt. Indirect application represents a temperature buffer that is adapted to the production requirements with cooling and heating through air conditioning.

A casing is mounted close to the ink application units so as to limit environmental influences. The theoretical ink application quantity determined on the digital plate printer for the decor is used to control the temperature gradation of the individual printing units. The ink units are increased in each case by 1° C. from unit 1 to unit 4 or unit 5. Particularly preferably: 1st printing unit 29° C.; 2nd printing unit 30° C.; 3rd printing unit 31° C.; 4th printing unit 32° C. and 5th printing unit 33° C.

Automatic condensation monitoring is achieved by means of laser inspection. If a laser detects condensation at an early stage, insertion is automatically stopped. A corresponding time gap is inserted during ongoing production to clean the heads. The board buffer is preferably filled in the upstream cooling paternoster. After cleaning, the boards are fed back into the printing process. As a result, an interval can be determined from the recorded data in relation to the production quantity for each decor. Particularly preferably, cleaning is performed at the best possible moment, for example when changing the decor or during another necessary interruption to production (for example when replacing the sanding belt).

The airflow deflectors with suction remove the air saturated with moisture from the print head area of the machine during production without affecting the ink flow. The printed boards are coated in melamine resin and dried again, then cooled to 30° C. in a cooling tower. They are subsequently transferred to a crane store for maturing.

### DETAILED DESCRIPTION OF DRAWINGS

In the following, a number of embodiment examples of the invention will be explained in more detail with the aid of the accompanying drawings. They show:

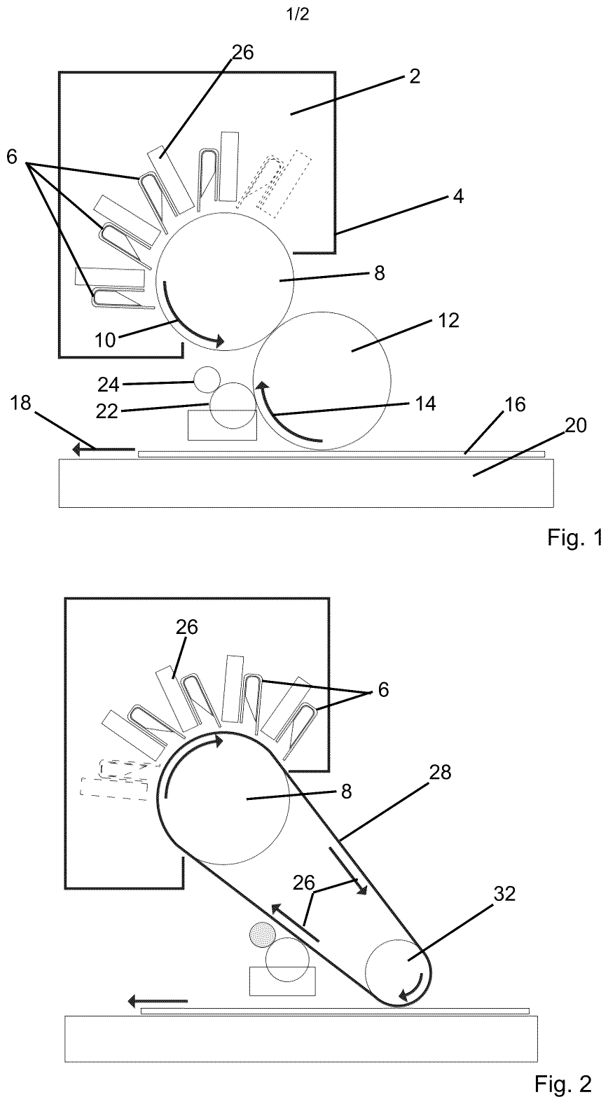

FIGS. 1 to 3 shows schematic representations of different embodiments of digital printing facilities according to embodiment examples of the present invention.

### DETAILED DESCRIPTION

FIG. 1 depicts a digital printing facility with a printing unit 2 surrounded by a housing 4. It has four ink application units 6, each of which can apply printing ink in one colour. A fifth ink application unit 6 is depicted with dashed lines. This is to illustrate that further ink application units 6 are an option. The ink application units 6 apply the printing ink to a printing cylinder 8, which constitutes the ink carrier element in this embodiment. It is rotated along the direction of the arrow 10, so that the printing cylinder 8 is guided past the ink application units 6. In the embodiment example shown, the direction of movement indicated by the arrow 10 thus represents the feed direction of the ink carrier element. The printing cylinder 8 is in contact with an application roller 12, which is rotated along the direction of the arrow 14. Due to the contact between the application roller 12 and the printing cylinder 8, the printing ink applied by the ink application units 6 is transferred from the printing cylinder 8 to the application roller 12.

The application roller 12 is rolled on an object 16 to be printed on. Said object is moved in the direction of transportation 18. A conveyor unit 20 is provided for this purpose. Once the surface of the application roller 12 has been rolled on the object 16 to be printed on, it comes into contact with a washing unit 22, the roller of which removes any residues from the surface of the application roller 12. The washing unit 22 has a dryer unit 24 which dries the roller of the washing unit 22, thereby preparing it to absorb any printing ink remaining on the application roller 12.

Within the housing 4 of the printing unit 2, a device 26 is arranged between each two neighbouring ink application units, said device being configured to reduce or completely prevent the build-up of condensation on the ink application units 6. In the embodiment example shown, the device 26 is an air suction unit, depicted only schematically, and an air flow deflector. The housing 4 also ensures a smaller build-up of condensation on the ink application units 6 and thus also constitutes part of the device 26.

FIG. 2 shows a different embodiment of a digital printing device. It too has ink application units 6, wherein a fifth ink application unit is shown by a dashed line and thus shown to be optional. Between each two neighbouring ink application units 6 there is another device 26 to reduce the formation of condensation. Unlike in FIG. 1, however, the ink carrier element is not a printing cylinder 8, but a print belt 28 that circulates in the direction of the arrows 30. In the embodiment example shown, the direction of the arrows 30 is therefore the feed direction of the ink carrier element.

The print belt 28 circulates around the printing cylinder 8 and a conveyor roller 32, by way of which the print belt 28 is also moved in the embodiment example shown. The remaining embodiments and details correspond to those of the embodiment in FIG. 1.

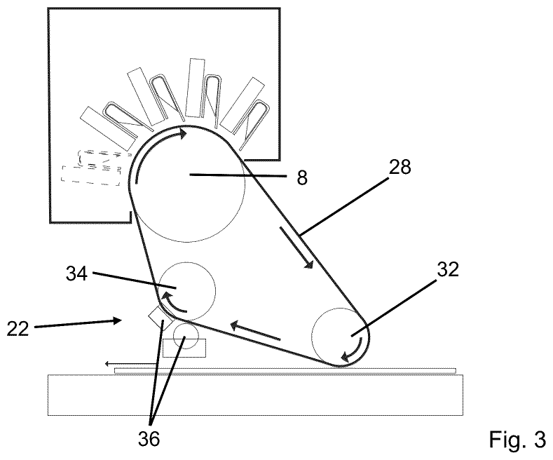

FIG. 3 depicts a further embodiment of a digital printing device according to an embodiment example of the present invention. Unlike the embodiment shown in FIG. 2, the print belt 28 in FIG. 3 not only circulates around the printing cylinder 8 and the conveyor roller 32, but also around a cleaning aid 34 above. The latter forms part of the washing unit 22, which features two cleaning squeegees 36 in the embodiment example shown. This embodiment also comprises the same devices 26 as the embodiments in FIGS. 1 and 2.

1. A method for printing on an object that is not paper by a digital printing facility comprising multiple ink application units for applying printing ink of different colours, the method comprising guiding an ink carrier element-past the ink application units in a feed direction, the digital printing facility comprising a device configured to prevent or reduce a build-up of condensation on the ink application units, and the build-up on condensation on the ink application units is prevented or reduced by the device, the device further comprising a temperature control device and an electrical control unit, the temperature control device being configured to influence a temperature of the ink application units and the electrical control unit being configured to control the temperature control device in such a way that the ink application units are at different temperatures, wherein the temperatures of the ink application units increase in the feed direction and the temperatures of two adjacent ink application units differ by at least 0.5° C. and at most 1.5° C., wherein the temperatures of a first ink application unit in the feed direction and a last ink application unit in the feed direction differ by at most 10° C.

2. The method according to claim 1, wherein the temperatures of the two adjacent ink application units differ by at least 0.7° C.

3. The method according to claim 1, wherein the temperatures of the first ink application unit in the feed direction and the last ink application unit in the feed direction differ by at most 7° C.

4. The method according to claim 1, wherein the device has at least one air stream deflector that is arranged between two ink application units and is configured and able to deflect an air flow from one ink application unit to an adjacent ink application unit.

5. The method according to claim 4, wherein the device has at least one air stream deflector between each two adjacent ink application units.

6. The method according to claim 1, wherein the device has at least one air suction device that is arranged between two ink application units and is configured and able to suck away air between the two ink application units.

7. The method according to claim 6, wherein the device has at least one air suction device between two adjacent ink application units in each case.

8. The method according to claim 1, wherein the device has a housing that encloses the ink application units.

9. The method according to claim 1, wherein the digital printing facility comprises a monitoring unit which is configured to detect athe build-up of condensation on at least one of the ink application units.

10. The device according to claim 1, wherein the ink carrier element isan object to be printed on.

11. The method according to one claim 1, wherein the ink carrier element is a transfer element.

12. A digital printing device that is able and configured to print on an object that is not paper using a method according to claim 1.

13. The method according to claim 1, wherein the temperatures of the first ink application unit in the feed direction and the last ink application unit in the feed direction differ by at most 5° C.

14. The method according to claim 1, wherein the temperatures of two adjacent ink application units differ by at least 1.0° C.

15. The method according to claim 1, wherein the temperatures of two adjacent ink application units differ by at most by 1.3° C.

16. The method according to claim 1, wherein the temperatures of two adjacent ink application units differ by at most 1.0° C.

17. The method according to claim 1, wherein the ink carrier element is a transfer roller or a transfer belt.
